(19) United States
(12) Patent Application Publication
(10) Pub. No.: US 2003/0127565 A1
(43) Pub. Date: Jul. 10, 2003

(54) Operation continue life pressurized parachutes

(76) Inventors: Bernard Haffen, Newark, NJ (US); Michael Jenkins, Newark, NJ (US); Theodore Higginbotham, Newark, NJ (US)

Correspondence Address: Bernard Haffen/Haffen Electronics, 53 Plymonth Street, Newark, NJ, 07106, US

(21) Appl. No.: 10/038,360

(22) Filed: Jan. 7, 2002

(51) Int. Cl. B64D 17/00; B64D 19/00

(52) U.S. Cl. 244/139

(57) ABSTRACT

An urgent purpose for solving the lost of life issue during airplane travel. This device comprises an integration of three pressurized parachutes, which are determined by the weight of each section of the airplane, also comprising an air compressor battery or generator that controls the constant air pressure and release valve of this system. However this system functions on its own by pushing the switch in the cockpit, then it releases the system. This system also runs off its own airflow system, not the airplanes pressurized functions. When releasing the system, pressurized air is released from holding the Air, Spring Rod Locking Shoes, this frees the arrow dynamic pressurized doors which are connected and manufactured with the fire proof parachute. This allows the parachute to spring out and do their job, also there can be another switch hooked to the system for a floatation on device that works the same way underneath the plane.

### BACKGROUND OF THE INVENTION

Presently there aren't systems available like this one in the Air Flight Navigation Industry. This device includes safety and reassurance of “Continuing Life” after taking aircraft travel. However parachutes are used in many situations dating back to the 1930's in World War II and today for personal usage and emergency Military situations.

However we know there are two forces that act on any falling object, air resistance and gravity. Gravity pulls the object quickly toward the earth, but air resists the object's movement. Because: the pull of gravity, is much stronger than the resistance of the air. The air can only slowdown the speed of the falling object, so Operation Continue Life System's change the aircraft into a glider which the Pilot can still have control of a broken or dead engine aircraft in midair. However this system allows the Pilot to have some control because of the aircraft's rutter system, the aircraft is still under his control. This system is similar to a personalized parachute, which the person has a steering line and riser in harness. By having this system embodied in an aircraft increases your chances of living by eighty percent. In general this invention consists of three specially made parachutes that are made with steel suspension lines—heavy nylon materials—a series of bolts that are connected to the skirt band—heavy nylon materials and welding to the pressurized doors on the inside of parachutes, which are determined by the weight of each airplane section. Each section supports its self during landing. However, these parachutes should have the same landing affects. This system should stop the airplane's motion of going into the nose down direction, if system is used properly. This system should be used as soon as engine has stopped or whatever failure has happened, this would definitely save lives. However the flexible steel suspension cables are welded to the aircraft's frame during manufacturing of the aircraft.

### BRIEF DESCRIPTION OF THE DRAWINGS

FIG. 1. Shows diagram that illustrates aircraft in full body with pressurized parachutes mounted or welded to pressurized doors in the present teachings.

FIG. 2. Shows diagram that illustrates manufacturing instructions components of combining aircraft and pressurized doors—welding and flexible steel suspension cables and bolted connections in the present teachings.

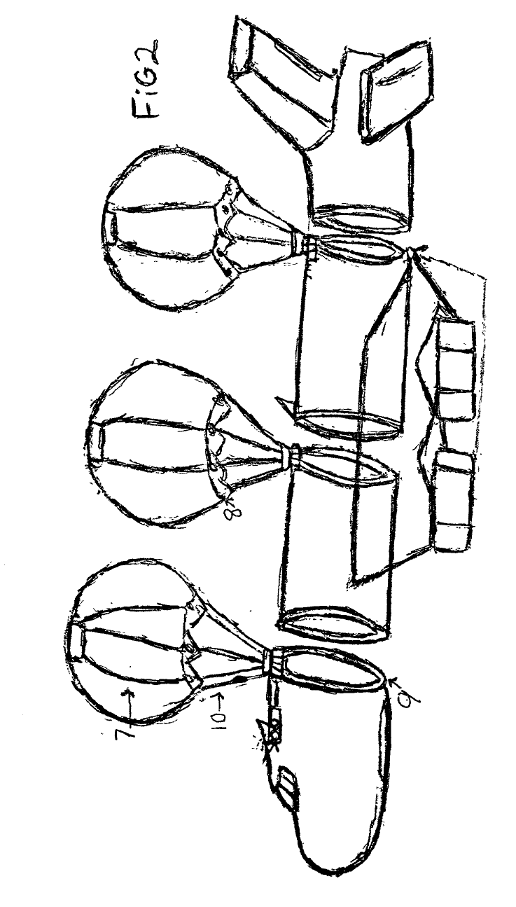

FIG. 3. Is a diagram illustrating the Air Block System that shows the mechanics of this invention and how it should work in accordance with the teachings of the present invention.

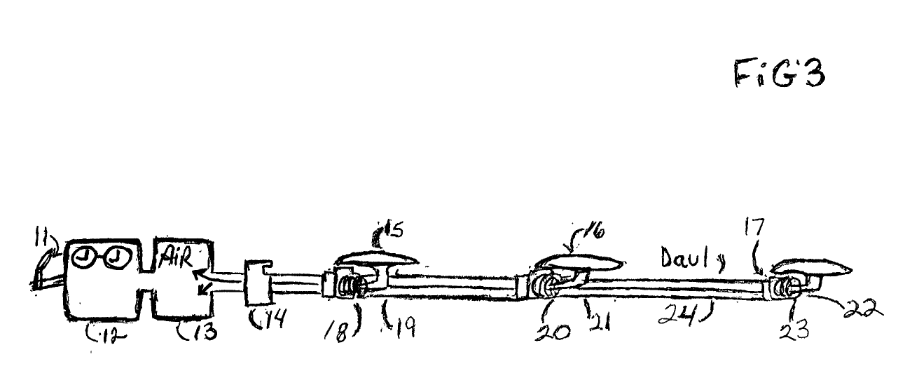

FIG. 4. Is a blocked diagram illustrating a first embodiment of a compacted pressurized parachute ready to open when Locking Shoes are released in accordance with teachings of this invention.

FIG. 5. Is a diagram illustrating a second embodiment of an aircraft and pressurized door and parachute system in accordance with the teachings of the present invention.

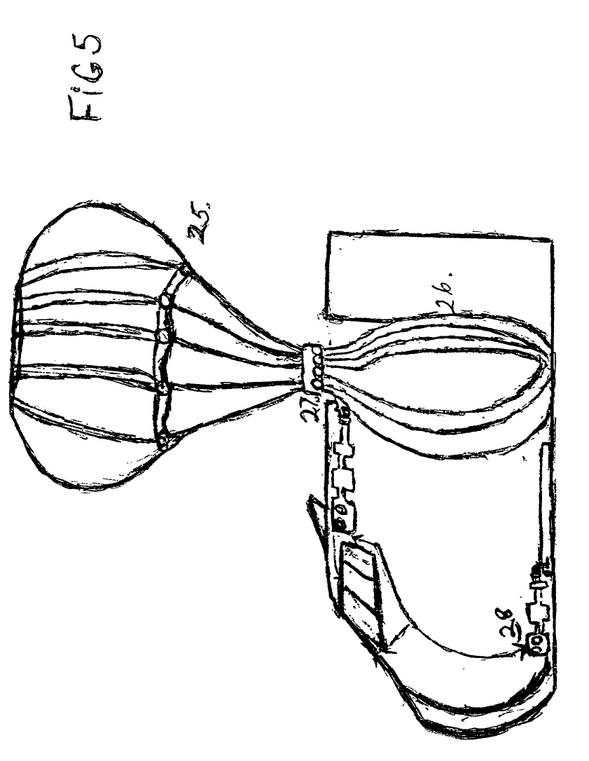

FIG. 6. Is a diagram illustrating how Operation Continue Life in working form when the system has been activated to save lives in accordance with the teachings of the present invention.

### DETAIL DESCRIPTION OF THE PREFERRED EMBODIMENTS

In general the teachings of the present invention pertains to the integration of a passenger aircraft and pressurized parachutes with a purpose of saving lives (“here in and after a purpose of or saving lives during aircraft travel”). This will be appreciated by those skilled in the art and as disclosed herein Operation Continue Life devices could include, but are not limited to large aircraft can be used in smaller aircraft also considering size and weight.

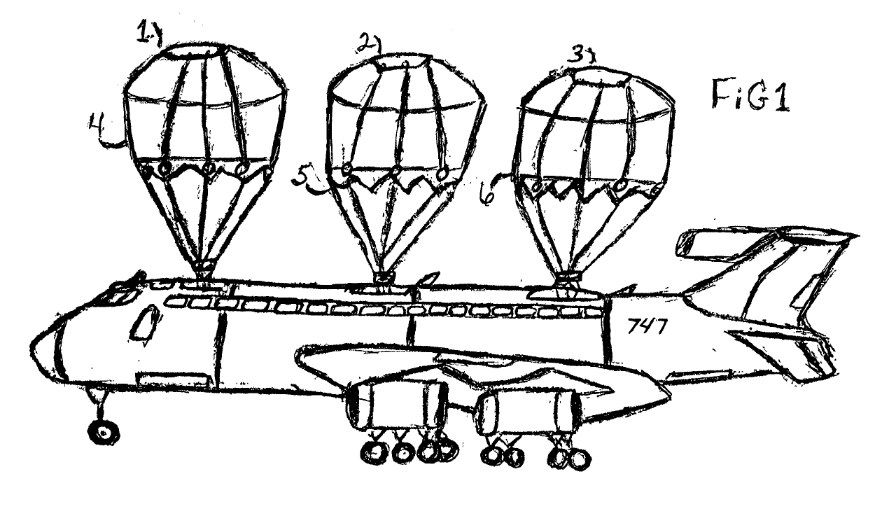

Referring Now to FIG. 1.

The purpose of continuing and saving lives during aircraft travel;

1. Pressurized door to one

2. Pressurized door two

3. Pressurized door three

4. Shows pressured parachute

5. Shows pressurized parachute number two

6. Shows pressurized parachute number three

7. Shows steel suspension in cables

8. Shows bolts or welding to the skirt band

9. Shows steel welded suspension cables around the circumference of the airplane frame in each section

10. Each cable is mounted, bolted, or welded to the parachute-pressurized door.

11. Shows the switch or switches that should be mounted in the cockpit, switch can be electronic or hydraulic.

12. Shows air compressors or generator- it is set at a certain air pressure to release system.

13. Shows diagram of Auxiliary Reservoir Tank that controls air intake.

14. Shows a diagram of the central valve that controls open close exhaust intake.

15. Master Cylinder pushes air pressure to the Air Spring Locking Shoes.

16. Master Cylinder.

17. Master Cylinder (However there are six Locking Shoes and Air Spring Rods).

18. Air Spring Rod Locking Shoe.

19. Air Spring Rod and Locking Shoe.

20. Air Spring Rod and Locking Shoe.

21. Air Spring Rod and Locking Shoe.

22. Air Spring Rod and Locking Shoe.

23. Air Spring Rod and Locking Shoe.

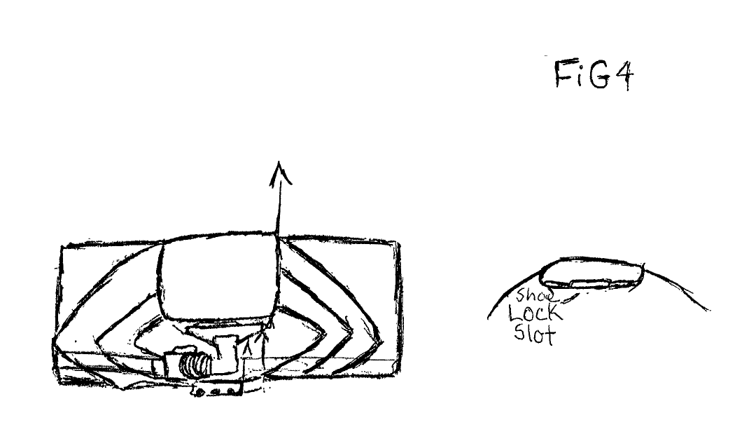

24. Is a diagram that illustrates an air pipe that allows air travel through and from the system. FIG. 4. Illustrates a diagram of the pressurized parachute when not in use.

25. Illustrates a diagram of the pressurized parachute in full body detailing the connection to the skirt band and how it is assembled by bolts or welding.

26. Illustrates a diagram of embodiment of welding of flexible steel suspension cables welded to the frame of the aircraft inside embodiment around passenger cabin.

27. Is a diagram that illustrates bolted or welded riser connected to the harness (note! The aircraft is the harness and support during its descent).

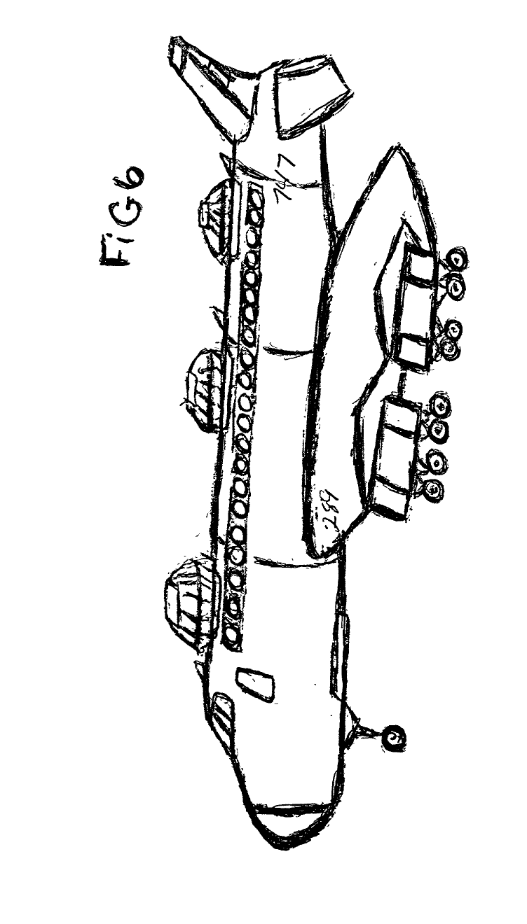

28. Is a diagram that illustrates the same set-up for floatation devices. FIG. 6. Is a diagram that illustrates how parachutes start to come out when switch is pushed during flight and landing gear is lowered in accordance to the teachings of this invention.

1. Continued Life's purpose of having pressurized parachutes embodied in aircraft's safety output device.

2. A first safety device that increases your chance of living doing aircraft travel.

3. A device that would help the Airline Industry solve many unexplained accidents and increase passenger thoughts of survival. Now you have a chance to live during air travel. No longer being helpless, having fear of dying if a problem occurs doing air travel.

4. A device that is controlled by set air pressure to release parachute device that works independently not connected to other airplane pressure functions.
